(19) United States
(12) Patent Application Publication
(10) Pub. No.: US 2026/0257629 A1
(43) Pub. Date: Sep. 3, 2026

(54) ROOF ARRANGEMENT HAVING A FIXED ROOF ELEMENT AND A HEADLINING

(71) Applicant: Webasto SE, Stockdorf (DE)

(72) Inventor: Thomas SCHRÖFERL, Stockdorf (DE)

(21) Appl. No.: 19/548,437

(22) Filed: Feb. 24, 2026

(30) Foreign Application Priority Data
Feb. 28, 2025 (DE) 10 2025 107 722.3

(51) Int. Cl. B60R 13/02; B62D 25/06

(52) U.S. Cl. CPC B60R 13/0212; B62D 25/06

(57) ABSTRACT

A roof arrangement of a motor vehicle has a fixed roof element, which is rigid and arranged so as not to be movable with respect to a roof substructure and has a panel made of glass and/or plastic, and a headlining having a lining element which forms an inner visible surface facing a vehicle interior and is attached to the fixed roof element. A retaining plate is attached to an underside of the panel by a shaped portion formed on the panel, the retaining plate being partially enclosed by the shaped portion and being fastened to the at least one lining carrier, which is engaged with a retaining geometry which is arranged on the side of the lining element facing away from the visible surface.

### CROSS-REFERENCE TO RELATED APPLICATIONS

This application claims the benefit of German patent Application No. 10 2025 107 722.3 filed February 28, 2025, which is incorporated herein by reference in its entirety.

### TECHNICAL FIELD

The disclosure relates to a roof arrangement of a motor vehicle, comprising the features in the preamble of claim 1.

### BACKGROUND

Such a roof arrangement is known from practice and may be used in particular in a passenger car. The roof arrangement comprises a fixed roof element, which forms a so-called fixed transparent module (FTM) and which is provided with a transparent panel made of glass or plastic, through which the ambient light can enter an interior of the motor vehicle in question. Furthermore, the known roof arrangement comprises a headlining, which, as seen from the vehicle interior, covers an outer, peripheral edge region of the fixed roof element. To hold the headlining or a lining element that effects the relevant covering of the fixed roof element, provision has previously been made of holding devices which are formed on a roof frame of the fixed roof element, via which roof frame the fixed roof element can be connected to a roof substructure secured to the bodyshell. In practice, there is frequently a gap between an upper edge of the lining element and the underside of the panel. The arrangement of the holding devices on the roof frame results in a long tolerance chain, and for this reason the formation of this gap frequently does not meet the imposed requirements from a visual point of view.

Also known are fixed roof elements which do not have a peripheral roof frame that supports the panel made of glass or plastic. Thus, in the regions without a roof frame, it is also no longer possible to attach a lining element via the roof frame.

Furthermore, it is known to equip a fixed roof element panel made of glass and/or plastic with an ambient light functionality. To realize this, respective lighting devices may be arranged in lateral edge regions of the panel, said devices comprising wedge-shaped light coupling-in elements which are attached to the underside of the panel and via which the light from a light source is able to be coupled into a light guide layer of the panel.

### SUMMARY

The disclosure addresses the problem of creating a roof arrangement configured in the manner described at the beginning, the lining element of which is attached precisely to the fixed roof element so as to ensure that the relevant edge region of the fixed roof element is covered in a manner meeting high visual demands, and it is also possible to cover the relevant lighting device in the case of an ambient light functionality for the transparent panel.

This problem is solved according to the disclosure by the roof arrangement having the features of claim 1.

Thus, the disclosure proposes a roof arrangement of a motor vehicle, which comprises a fixed roof element and a headlining with a lining element. The fixed roof element is rigid and arranged so as not to be movable with respect to a roof substructure and comprises an in particular transparent panel made of glass and/or plastic. The lining element, which may be rigid or at least locally flexible, forms an inner visible surface facing a vehicle interior and is attached to the fixed roof element, specifically, according to the disclosure, such that a retaining plate is attached to an underside of the panel by means of a shaped portion formed on the panel, the retaining plate being at least partially enclosed by the shaped portion and being fastened to the at least one lining carrier, which is engaged with a retaining geometry which is arranged on the side of the lining element facing away from the visible surface.

The in particular transparent panel of the fixed roof element thus has, on its side facing the vehicle interior, a shaped portion made of plastic which has been produced by an injection-molding process or foaming process and in which the retaining plate is embedded in the manner of an inlay or insert. In the process, during the production of the shaped portion, which is foamed or molded onto the panel, the retaining plate is thus attached to the panel without the use of further fastening means. The retaining plate forms a base for fastening the lining carrier, on which the lining element is supported by appropriate engagement of the retaining geometry. The securing of the lining carrier, formed in particular in a bracket-like manner, to the retaining plate attached directly to the underside of the panel results in a relatively small distance between the shaped portion and the connection between the lining carrier and the lining element. As a result, it is possible to fasten the lining carrier to the underside of the panel of the fixed roof element in a defined manner with low tolerances. Any gap between the lining element and the panel can thus be designed in a defined manner with a positive visual impression. The retaining plate is preferably a bent part made of a metallic material, but may also be made from a plastic material.

The fixed roof element may form a so-called fixed transparent module (FTM) which is provided with a transparent panel made of glass or plastic, through which the ambient light can enter an interior of the motor vehicle in question. In addition, it is conceivable for the roof arrangement according to the disclosure to be equipped with a roof opening system that comprises an adjustable covering element, by means of which a roof opening is selectively able to be opened or closed. The roof opening system and the fixed roof element may, in this case, be constituent parts of one and the same module, which is part of a roof arrangement designed according to the disclosure.

The visible surface of the lining element is that surface that is exposed on the roof inner side, which delimits the passenger compartment of the vehicle in question, and may comprise surface regions that are placed at any desired angle with respect to the underside of the panel or are oriented parallel to the underside of the panel. This also includes lateral surfaces of the headlining that border the underside of the panel via the gap.

In order for it to be as easy as possible to fit the roof arrangement according to the disclosure, in a preferred embodiment of the roof arrangement according to the disclosure, the lining carrier is latched in place on the retaining plate. For example, the lining carrier has detents that can be inserted into corresponding cutouts in the retaining plate and can be latched in place there.

In order to give the structure for attaching the lining element to the panel a high level of stiffness, in a preferred embodiment of the roof arrangement according to the disclosure, the retaining plate has two legs which are each connected to a securing portion of the lining carrier. For example, the retaining plate is an angle plate made of metal or plastic, from which one leg is oriented substantially parallel to the underside of the panel and another leg is oriented at right angles to the underside of the panel. Respective securing portions of the lining carrier may be secured to the two legs.

In order to cover functional devices or the like, a cover element may be arranged on the underside of the panel. Such a functional device is formed, for example, by an ambient lighting device which is attached to the underside of the panel. The cover element is manufactured, for example, from a strip-form plate, in the form of a bent part, made of a metallic material, or is a plastic cover, which is in particular in the form of a strip.

In a particular embodiment of the roof arrangement according to the disclosure, the cover element is likewise fastened to the retaining plate. The retaining plate then thus serves both for fastening the lining carrier and for fastening the cover element.

In order to make it as easy as possible to fit the embodiment having a cover element, in a particular embodiment of the roof arrangement according to the disclosure, the retaining plate, the cover element and the lining carrier have a common connecting region. The common connecting region is designed, for example, such that a securing portion of the lining carrier passes through a cutout in the cover element and the securing portion is latched in place in a cutout in the retaining plate. This results in a sandwich structure.

In order to make a receiving space that is formed between the cover element and the underside of the panel as light-tight as possible, the cover element may have an edge, formed in particular by folding, that bears against the shaped portion, via which the retaining plate is attached to the panel, and that engages in particular in a corresponding groove in the shaped portion. As a result of the cover element being fastened to the retaining plate, it is possible to dispense with an adhesive bond between the cover element and the panel, at least at this edge.

In order to ensure that the cover element bears in particular without rattling against the underside of the panel in the edge region, facing away from the shaped portion, of the cover element, in a preferred embodiment of the roof arrangement according to the disclosure, the cover element bears against the panel via a sealing and/or insulating tape. By way of example, the sealing and/or insulating tape is a foam tape which is adhesively bonded to the cover element and bears loosely against the underside of the panel. When the cover element covers a lighting device, it is advantageous when the sealing and/or insulating tape is a light-tight adhesive tape which is also adhesively bonded to the underside of the panel.

The in particular transparent panel of the fixed roof according to the disclosure has in particular an in particular peripheral edge foaming comprising a foam material, for example of a polyurethane foam material. In this case, the shaped portion for securing the retaining plate to the panel is in particular likewise made from the foam material. The shaped portion and the edge foaming are then in particular produced in the same process step in the same mold.

As already set out above, the roof arrangement according to the disclosure may comprise a lighting device under which the cover element at least partially engages, i.e. which is arranged between the panel and the cover element attached to the underside of the panel. In the case of an ambient lighting device, a light source and a light coupling-in device may be provided, which bears against the underside of the panel and couples the light from the light source into the panel. The panel is in the form, for example, of a laminated glass pane, which is constructed from a plurality of pane bodies that are connected together. The glass body forming the underside of the laminated pane in this case forms a light guide layer, into which the light from the light source is able to be coupled via the light coupling-in device. The light coupling-in device is formed, for example, from a plurality of wedge-shaped, transparent plastic parts, which have been adhesively bonded to the underside of the panel. The light source, which may be in the form of an LED strip or PCB (printed circuit board) with a plurality of LEDs, bears against the light coupling-in device. The light source and the light coupling-in device are located in particular in the receiving space between the cover element and the underside of the laminated pane.

The disclosure also relates to a motor vehicle having a roof arrangement of the type described above.

Further advantages and advantageous configurations of the subject matter of the disclosure can be gathered from the description, the drawing and the claims. The scope of the disclosure includes all combinations of at least two features disclosed in the description, the claims and/or the figures, i.e. each feature mentioned in the description or shown in the figures may be part of the claimed subject matter independently of the further features and/or specifications mentioned or shown in the particular context.

### BRIEF DESCRIPTION OF DRAWINGS

An exemplary embodiment of a motor vehicle having a roof arrangement according to the disclosure is illustrated in a schematically simplified manner in the drawing and will be explained in more detail in the following description. In the drawing:

FIG. 1 shows a perspective plan view of a motor vehicle having a roof arrangement;

FIG. 2 shows a plan view of a fixed roof element of the roof arrangement;

FIG. 3 shows a section through the roof arrangement along the line III-III in FIG. 1;

FIG. 4 shows an assembly step for securing a lining carrier; and

FIG. 5 shows the lining carrier in the assembled state.

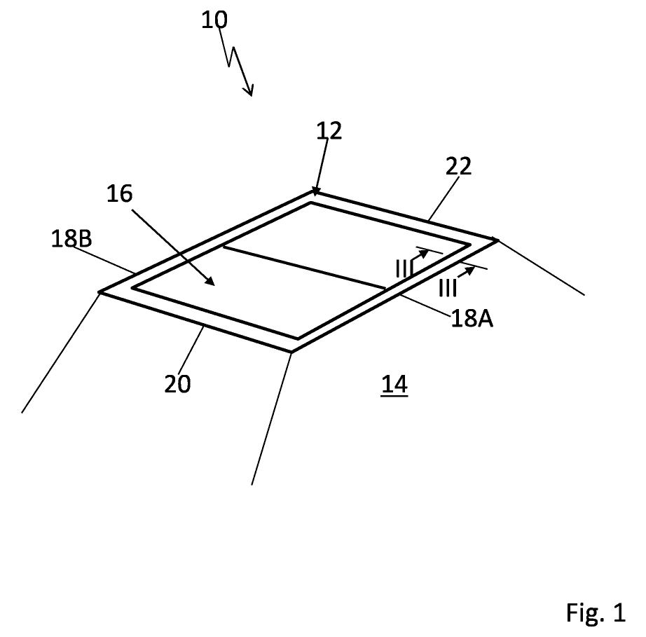

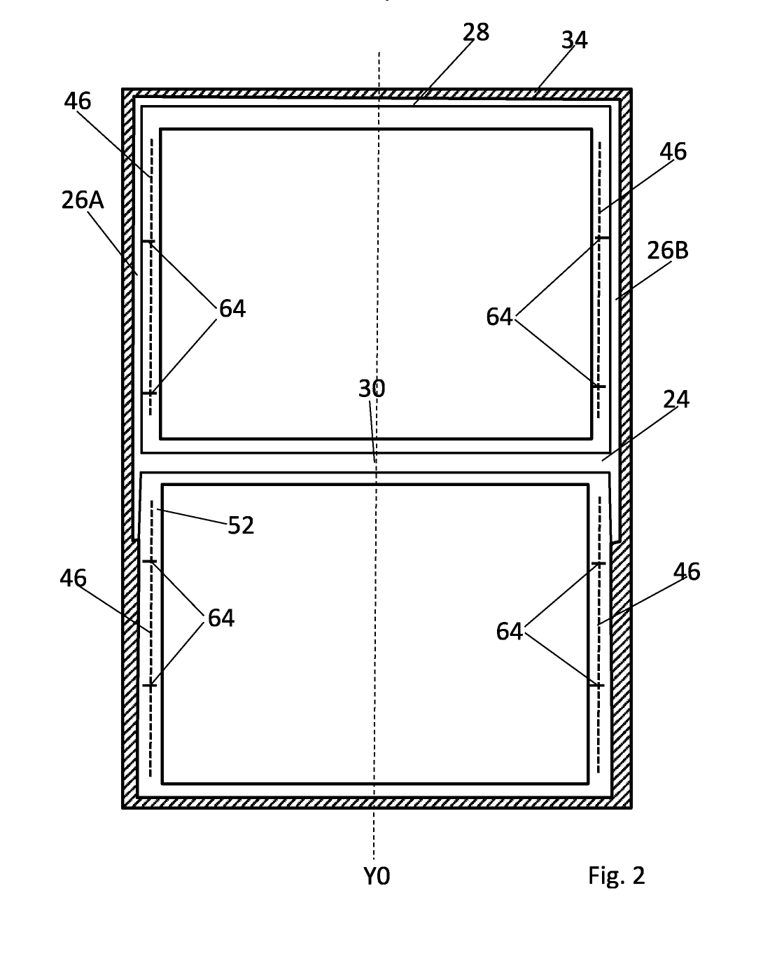

### DETAILED DESCRIPTION

Illustrated in the drawing is a motor vehicle 10, which is in the form of a passenger car and has a roof arrangement 12 that spans a vehicle interior.

The roof arrangement 12 comprises a fixed roof element 16, which is rigid and thus arranged so as not to be movable with respect to a roof substructure that has, inter alia, lateral longitudinal roof beams 18A and 18B, which laterally delimit the fixed roof element 16 and form lateral edges of the roof arrangement, a front transverse roof beam or cowl 20 and a rear transverse roof beam or rear cowl 22. The longitudinal roof beams 18, the front transverse roof beam 20 and the rear transverse roof beam 22 are thus assigned to the roof substructure in the present case.

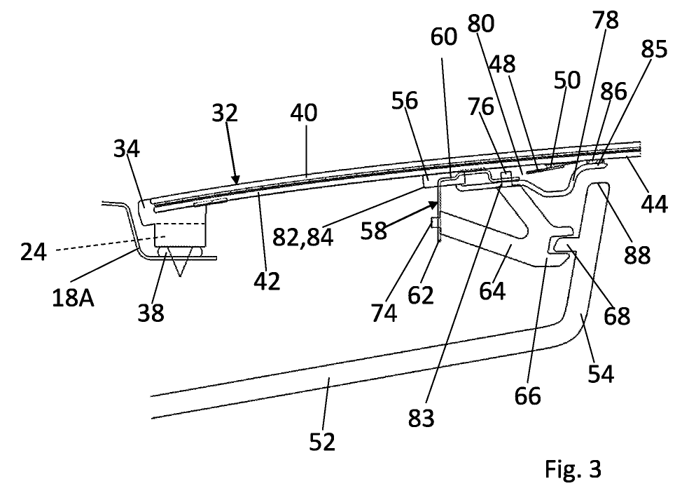

The fixed roof element 16 comprises a roof frame 24 which is manufactured from a metal sheet and comprises two longitudinal frame legs 26A and 26B and a front transverse frame leg 28 and a central transverse frame leg 30. The longitudinal frame legs 26A and 26B extend from the front transverse frame leg 28 with a certain rearward overhang beyond the central transverse frame leg 30. The roof frame is thus a so-called A-frame. In addition, the fixed roof element 16 comprises a transparent panel 32, which is formed from a laminated glass pane and is provided peripherally with an edge foaming 34 that has been produced from a polyurethane foam and delimits the panel 32 peripherally at its edges. The panel 32 in the region of the edge foaming 34 has been adhesively bonded to the roof frame 24 via a glue bead (not illustrated in more detail). To the rear side of the longitudinal frame legs 26A and 26B, the edge foaming 34, which is widened there, exhibits an abrupt increase in thickness in the vehicle vertical direction, such that an underside of the roof frame 24 transitions into the underside of the edge foaming 34 in a flush manner. The edge foaming 34 thus represents a continuation of the roof frame 24 to the rear side of the longitudinal frame legs 26A and 26B, this being indicated by dashed lines in FIG. 3. The fixed roof element 16 has been adhesively bonded to corresponding flange portions of the longitudinal roof beams 18A and 18B, of the front transverse roof beam 20 and of the rear transverse roof beam 22 by means of a further glue bead 38 via the roof frame 24 and the regions of the edge foaming 34 that are formed to the rear side of the roof frame 24.

The laminated pane of the panel 32 comprises an outer pane body 40 and an inner pane body 42, which is connected to the outer pane body 40 via an intermediate layer and which has an underside 44 that forms a visible surface, accessible from the vehicle interior 14 of the panel 32. Furthermore, the roof arrangement 12 is provided with a lighting device in the form of ambient lighting, which comprises respective lighting devices 46 on both sides with respect to a vertical roof longitudinal center plane Y0. The lighting devices 46 each comprise an LED strip in the form of a PCB (printed circuit board) 48, which is provided with a plurality of LEDs, and several wedge-shaped light coupling-in elements 50 which are arranged successively in the vehicle longitudinal direction and the number of which corresponds to the number of LEDs and which have been adhesively bonded to the underside 44 of the panel 32. Light from the LEDs of the LED strip 48 is coupled into the inner pane body 42, forming a light guide layer, by means of corresponding light deflection in the light coupling-in elements 50. Light coupling-out elements that are distributed over the surface of the inner pane body 42 and may consist, for example, of imprinted scattering centers or the like, create a light pattern, visible from the vehicle interior 14, on the inner side of the panel 32.

The roof arrangement 12 furthermore comprises a headlining 52, which forms a visible surface, accessible from the vehicle interior 14, of the roof arrangement 12 and which comprises a lining element 54 that covers the fixed roof element 16, as can be seen in FIG. 3, in its edge region.

For attachment to the fixed roof element 16, the panel 32 comprises, on its underside 44, a shaped portion 56 which extends parallel to the edge foaming 34 and has likewise been produced from the polyurethane foam material. The shaped portion 56 and the edge foaming have been formed on the panel 32 in the same process step in the same mold. The shaped portion 56 represents partial foaming of a retaining plate 58, consequently in the form of an insert, which is a stamped/bent part and comprises a first leg 60, arranged at right angles to the underside 44 of the panel 32, and a second leg 62, substantially following the underside 44 of the panel 32. The leg 62 has a central region that is in the form of an inverted trough in cross section and bears with its top side directly against the underside 44 of the panel 32. The shaped portion 56 for attaching the retaining plate 58 is located between the lighting device 46 and the edge foaming 34 of the panel 32.

Fastened to the retaining plate 58 is a lining carrier 64, which is latched in place on one side on the first leg 60 and on the other side on the second leg 62 of the retaining plate 58. In the end region facing away from the retaining plate 58, the lining carrier 64 has an engagement geometry 66 which is engaged with a retaining geometry 68 that is formed on the side of the lining element 54 that faces away from the visible surface of the latter.

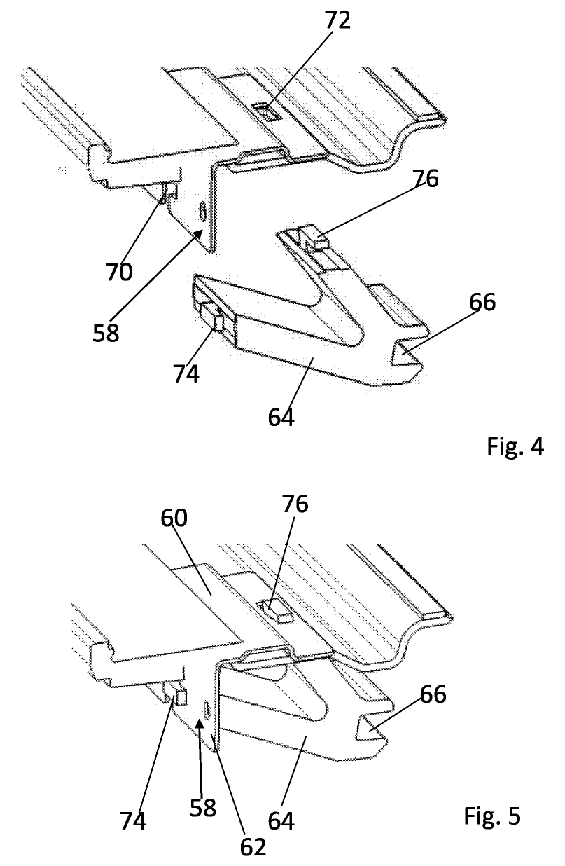

To secure the lining carrier 64, the two legs 60 and 62 of the retaining plate 58 each have a latching cutout 70 and 72, respectively, into which latching protrusions 74 and 76 engage, which are formed integrally in securing regions of the lining carrier 64. The latching protrusions 74 and 76 are, for example, each formed from a cross-sectionally T-shaped protuberance, which allows captive fastening in the region of the latching cutouts 70 and 72. As can be gathered from FIG. 4, the two latching protrusions 74 and 76 can be inserted into the latching cutouts 70 and 72 via opening slots and latching in place there by a transverse offset.

Several lining carriers 64 may be arranged along the roof frame 24 and along the regions of the edge foaming 34 that are arranged to the rear side of the roof frame 24, said lining carriers each being secured to a retaining plate 58 of the described type or at least partially to a common retaining plate.

Furthermore, a cover element 78 engages under the lighting device 46, such that the LED strip 48 and the light coupling-in elements 50 are received in a light-tight manner downwardly and in a transverse direction in a receiving space 80 that is formed between the cover element 78 and the underside 44 of the panel 32. To form a common connecting region, the cover element 78 has, in the region of the latching protrusion 76 of the lining carrier 64, a hole 83 through the latching protrusion 76 in question passes such that the cover element 78 is sandwiched between the lining carrier 64 in question and the retaining plate 58 and is thus secured to the underside 44 of the panel 32.

The cover element 78, which is made from plastic or metal, has an outer edge 82, facing away from the vehicle longitudinal center plane Y0, which engages in a groove 84 in the shaped portion 56. In a second edge region 85 facing away from the edge 82, the cover element 78 is adhesively bonded to the underside 44 of the panel 32 via a light-tight, double-sided adhesive tape 86.

An upper edge 88 of the lining element 54 is spaced apart from the edge region 85 of the cover element 78 via a defined edge gap.

When the fixed roof element 16 has no lighting devices 46, it is possible to omit the light-tight adhesive tape 86 for adhesively bonding the cover element 78 to the panel 32. Instead, it may then merely be necessary to prevent rattling of the cover element 78 on the panel 32 when the vehicle in question is being driven. To this end, rather than the light-tight adhesive tape 86, a foam tape or the like may be arranged between the cover element 78 and the underside 44 of the panel 32.

### LIST OF REFERENCE SIGNS

10 Motor vehicle

12 Roof arrangement

14 Vehicle interior

16 Fixed roof element

18A, B Longitudinal roof beam

20 Front transverse roof beam

22 Rear transverse roof beam

24 Roof frame

26A, B Longitudinal frame leg

28 Transverse frame leg

30 Transverse frame leg

32 Panel

34 Edge foaming

38 Glue bead

40 Outer pane body

42 Inner pane body

44 Underside

46 Lighting device

48 LED strip

50 Light coupling-in element

52 Headlining

54 Lining element

56 Shaped portion

58 Retaining plate

60 Leg

62 Leg

64 Lining carrier

66 Engagement geometry

68 Retaining geometry

70 Latching cutout

72 Latching cutout

74 Latching protrusion

76 Latching protrusion

78 Cover element

80 Receiving space

82 Edge

83 Hole

84 Groove

85 Edge region

86 Adhesive tape

88 Edge

1. A roof arrangement of a motor vehicle, comprising:
a fixed roof element, which is rigid and arranged so as not to be movable with respect to a roof substructure and comprises a panel made of glass and/or plastic, and
a headlining having a lining element which forms an inner visible surface facing a vehicle interior and is attached to the fixed roof element,
wherein a retaining plate is attached to an underside of the panel by a shaped portion formed on the panel, the retaining plate being partially enclosed by the shaped portion and being fastened to the at least one lining carrier, which is engaged with a retaining geometry which is arranged on the side of the lining element facing away from the visible surface.

2. The roof arrangement as claimed in claim 1, wherein the lining carrier is latched in place on the retaining plate.

3. The roof arrangement as claimed in claim 1, wherein the retaining plate has two legs which are each connected to a fixing portion of the lining carrier.

4. The roof arrangement as claimed in claim 1, wherein a cover element is arranged on the underside of the panel, the cover element being fastened to the retaining plate.

5. The roof arrangement as claimed in claim 4, wherein the retaining plate, the cover element and the lining carrier have a common connecting region.

6. The roof arrangement as claimed in claim 4, wherein the cover element has an edge that bears against the shaped portion.

7. The roof arrangement as claimed in claim 4, wherein the cover element bears against the panel via a sealing and/or insulating tape.

8. The roof arrangement as claimed in claim 7, wherein the sealing and/or insulating tape is a light-tight adhesive tape.

9. The roof arrangement as claimed in claim 1, wherein the panel has a peripheral edge foaming comprising a foam material, and the shaped portion is likewise made from the foam material.

10. The roof arrangement as claimed in claim 1, comprising a lighting device under which the cover element at least partially engages.

11. The roof arrangement as claimed in claim 10, wherein the lighting device comprises a light source and a light coupling-in device, which bears against the underside of the panel and couples the light from the light source into the panel.

12. A motor vehicle comprising a roof arrangement as claimed in claim 1.

13. The roof arrangement as claimed in claim 3, wherein the two legs which are each connected to the fixing portion of the lining carrier is formed in a bracket-like manner.

14. The roof arrangement as claimed in claim 6, wherein the cover element edge that bears against the shaped portion engages in a groove in the shaped portion.
